(19) United States
(12) Patent Application Publication
(10) Pub. No.: US 2024/0320666 A1
(43) Pub. Date: Sep. 26, 2024

(54) ELECTRONIC DEVICE COMPRISING PLURALITY OF EXECUTION ENVIRONMENTS AND OPERATING METHOD THEREOF

(71) Applicant: Samsung Electronics Co., Ltd., Suwon-si (KR)

(72) Inventors: Sungjin PARK, Suwon-si (KR); Youna LEE, Suwon-si (KR); Juyoung KIM, Suwon-si (KR); Minkyung SHIN, Suwon-si (KR); Seongmin JE, Suwon-si (KR)

(21) Appl. No.: 18/734,564

(22) Filed: Jun. 5, 2024

Related U.S. Application Data
(63) Continuation of application No. PCT/KR2022/015288, filed on Oct. 11, 2022.

(30) Foreign Application Priority Data
Dec. 8, 2021 (KR) 10-2021-0175017

(51) Int. Cl. G06Q 20/38; G06Q 20/40

(52) U.S. Cl. CPC G06Q 20/3829; G06Q 20/3825; G06Q 20/407

(57) ABSTRACT

An electronic device is provided. The electronic device includes a display, a communication circuit, memory storing computer-executable instructions including a first application for execution a first execution environment and a second application for execution in a second execution environment, a state detection circuit, and at least one processor communicatively coupled to the state detection circuit, the memory, the communication circuit, and the display, and configured to execute at least one of the first application in the first execution environment or the second application in the second execution environment. The computer-executable instructions, when executed by the at least one processor, may cause the electronic device to acquire, in the second execution environment, a signature request for a transaction generated through the first application, acquire first state data through the state detection circuit in response to the signature request, determine, based on the first state data, whether a signature condition stored in the second execution environment is satisfied, generate, based on the determination result, signature data by executing a digital signature for the transaction with a private key stored in the second execution environment, and transmit the signature data to the first application.

### CROSS-REFERENCE TO RELATED APPLICATION(S)

This application is a continuation application, claiming priority under § 365(c), of an International application No. PCT/KR2022/015288, filed on Oct. 11, 2022, which is based on and claims the benefit of a Korean patent application number 10-2021-0175017, filed on Dec. 8, 2021, in the Korean Intellectual Property Office, the disclosure of which is incorporated by reference herein in its entirety.

### BACKGROUND

### 1. Field

The disclosure relates to a technique of an electronic device which operates a plurality of execution environments.

### 2. Description of Related Art

In networks, a blockchain network is a network distinct from a centralized network in which decisions are made by a central server, and may be expressed as a decentralized network. The blockchain network may refer to a network in which decisions are made according to a consensus algorithm of nodes participating in the blockchain network.

An electronic device which acts as a client included in the blockchain network may use a public key and private key for the blockchain network to perform an operation related to transaction verification. For example, the electronic device may generate a transaction, and may execute a digital signature for the transaction by using the private key. The digital signature may be a technology for preventing electronic or digital documents from being falsified and for identifying an entity which has generated the signature. The electronic device may execute the digital signature for the transaction to prevent the transaction from being falsified and to authenticate the entity for generating the transaction.

The electronic device may use a private key generated using seed value (e.g., root seed) information when executing the digital signature. For example, the electronic device may generate a seed value in its own way (e.g., a True Random Number Generator (TRNG)), and may generate the private key, based on the generated seed value. In addition, the electronic device may generate a public key corresponding to the private key.

The above information is presented as background information only to assist with an understanding of the disclosure. No determination has been made, and no assertion is made, as to whether any of the above might be applicable as prior art with regard to the disclosure.

### SUMMARY

An electronic device may operate an execution environment having a plurality of security levels to enhance security. For example, the plurality of execution environments may include a first execution environment (e.g., a Rich Execution Environment (REE)) and a second execution environment (e.g., a Trusted Execution Environment (TEE)) or a security execution environment. A private key used in a blockchain network may cause a serious security problem when exposed to a third party. Therefore, the electronic device may store the private key in a secure area in the second execution environment (e.g., the TEE) requiring a relatively high security level. Alternatively, the electronic device may store the private key in an additional external device (e.g., a cold wallet and/or a hardware wallet).

The electronic device which has stored the private key in an additional area may access the area (e.g., by requesting a secure area or by connecting an external device) whenever the private key needs to be used in the blockchain network, and may perform an operation (e.g., a digital signature) using the private key. However, when the electronic device performs the operation using the private key in the second execution environment (e.g., the TEE), there is a disadvantage in that various conditions are not usable in the operation.

Aspects of the disclosure are to address at least the above-mentioned problems and/or disadvantages and to provide at least the advantages described below. Accordingly, an aspect of the disclosure is to provide a technique of an electronic device which operates a plurality of execution environments.

Additional aspects will be set forth in part in the description which follows and, in part, will be apparent from the description, or may be learned by practice of the presented embodiments.

In accordance with an aspect of the disclosure, an electronic device is provided. The electronic device includes a display, a communication circuit, memory storing computer-executable instructions including a first application for execution in a first execution environment and a second application for execution in a second execution environment, a state detection circuit, and at least one processor communicatively coupled to the state detection circuit, the memory, the communication circuit, and the display, and configured to execute at least one of the first application in the first execution environment or the second application in the second execution environment. The computer-executable instructions, when executed by the at least one processor, may cause the electronic device to acquires, in the second execution environment, a signature request for a transaction generated through the first application, acquires first state data through the state detection circuit in response to the signature request, determines, based on the first state data, whether a signature condition stored in the second execution environment is satisfied, generates, based on the determination result, signature data by executing a digital signature for the transaction with a private key stored in the second execution environment, and transmits the signature data to the first application.

In accordance with another aspect of the disclosure, a method performed by an electronic device capable of operating a plurality of execution environments including a first execution environment and a second execution environment is provided. The method may include acquiring, in the second execution environment, a signature request for a transaction generated through a first application executed in the first execution environment, acquiring first state data through a state detection circuit included in the electronic device in response to the signature request, determining, based on the first state data, whether a signature condition stored in the second execution environment is satisfied, generating, based on the determination result, signature data by executing a digital signature for the transaction with a private key stored in the second execution environment, and transmitting the signature data to the first application.

In accordance with another aspect of the disclosure, an electronic device is provided. The electronic device includes a display, a communication circuit, memory storing computer-executable instructions including a first application for execution in a first execution environment and a second application for execution in a second execution environment, a state detection circuit, and at least one processor communicatively coupled to the state detection circuit, the memory, and the display, and configured to execute at least one of the first application in the first execution environment or the second application in the second execution environment. The computer-executable instructions, when executed by the at least one processor, may cause the electronic device to acquire, in the second execution environment, a signature request for a transaction generated through the first application, acquire first state data through the state detection circuit in response to the signature request, determine, based on the first state data, whether a signature condition stored in the second execution environment is satisfied, transmit the determination result to the first application, and control the display to display a result screen indicating the determination result and information on the signature condition in the first execution environment.

In accordance with another aspect of the disclosure, a non-transitory computer readable storage media storing computer-executable instructions including a first application for execution in a first execution environment and a second application for execution in a second execution environment, that, when executed by at least one processor of an electronic device cause the electronic device to perform operations. The operations may include acquiring, in the second execution environment, a signature request for a transaction generated through the first application, acquiring first state data through the state detection circuit in response to the signature request, determining, based on the first state data, whether a signature condition stored in the second execution environment is satisfied, generating, based on the determination result, signature data by executing a digital signature for the transaction with a private key stored in the second execution environment, and transmitting the signature data to the first application.

In accordance with another aspect of the disclosure, a non-transitory computer readable storage media storing computer-executable instructions including a first application for execution in a first execution environment and a second application for execution in a second execution environment, that, when executed by at least one processor of an electronic device cause the electronic device to perform operations. The operations may include acquiring, in the second execution environment, a signature request for a transaction generated through the first application, acquiring first state data through the state detection circuit in response to the signature request, determining, based on the first state data, whether a signature condition stored in the second execution environment is satisfied, transmitting the determination result to the first application, and displaying a result screen indicating the determination result and information on the signature condition in the first execution environment.

According to various embodiments disclosed in the disclosure, an electronic device or method for allowing a user to set a condition is provided for a case where the user uses data stored in a second execution environment (e.g., a Trusted Execution Environment (TEE)) or performs an operation in the second execution environment. For example, the user of the electronic device sets the condition such that the data stored in the second execution environment is usable only at a specified location. Alternatively, the user of the electronic device sets the condition such that the operation is performed in the second execution environment only at the specified location.

According to an embodiment, when the electronic device uses the data stored in the second execution environment, it is restricted such that the data is used only when a specified condition is satisfied. For example, when the electronic device executes a signature for a transaction using a private key, it is restricted such that a signature operation is performed only when the specified condition is satisfied. Alternatively, when the electronic device performs an operation in the second execution environment, it is restricted such that the signature operation is performed only when the specified condition is satisfied.

According to various embodiments, the user of the electronic device is restricted to perform an operation only when a condition set by the user is satisfied in addition to the use of the second execution environment requiring a high security level compared to a first execution environment, thereby achieving higher security than using of the second execution environment.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 illustrates an execution environment of an electronic device according to an embodiment of the disclosure;

FIG. 3 is a flowchart for explaining an electronic device which executes a digital signature for a transaction according to an embodiment of the disclosure;

FIG. 4 is a flowchart for explaining an operation of an electronic device which executes a digital signature, based on that a signature condition is satisfied, according to an embodiment of the disclosure;

FIG. 5 is a flowchart for explaining an operation of an electronic device which sets a signature condition according to an embodiment of the disclosure;

FIG. 6 is a flowchart for explaining an operation of displaying a screen indicating whether an electronic device satisfies a signature condition according to an embodiment of the disclosure;

FIG. 7 illustrates a User Interface (UI) for executing a blockchain application according to an embodiment of the disclosure;

FIG. 8 illustrates a UI for setting a signature condition according to an embodiment of the disclosure;

FIG. 9 illustrates a UI for generating a transaction according to an embodiment of the disclosure;

FIG. 10 illustrates a result UI on whether a signature condition is satisfied according to an embodiment of the disclosure; and

FIG. 11 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

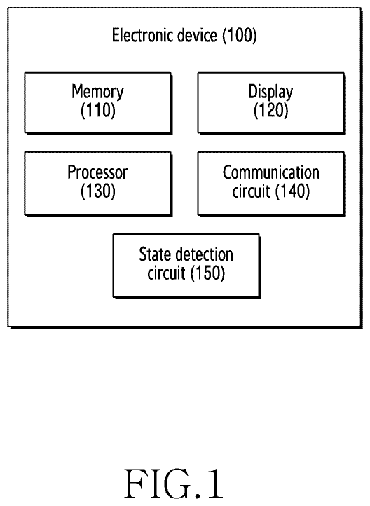

FIG. 1 is a block diagram of an electronic device according to an embodiment of the disclosure.

Referring to FIG. 1, an electronic device 100 may include memory 110, a display 120, a processor 130, a communication circuit 140, a state detection circuit 150, or a combination of them. In various embodiments, the electronic device 100 may include an additional component in addition to components illustrated in FIG. 1, or some of the components of FIG. 1 may be omitted.

FIG. 1 is for explaining the component of the electronic device 100 according to an embodiment, and is not limited to an expression thereof. The memory 110 may be referred to as a storage means for storing data. The display 120 may be referred to as an output means. The processor 130 may be referred to as a processing means for processing data. The communication circuit 140 may be referred to as a communication means for performing communication with another device. The state detection circuit 150 may be referred to as a state detection means for detecting a state.

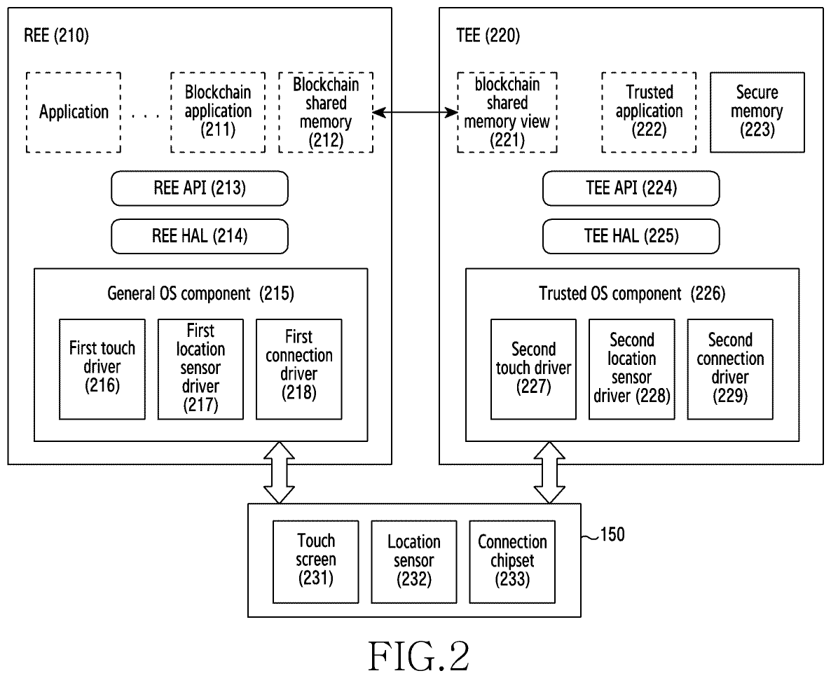

According to an embodiment, the electronic device 100 may operate based on at least one of a plurality of execution environments. The electronic device 100 may execute at least one application, based on at least one of the plurality of execution environments. For example, the plurality of execution environments may include a first execution environment (e.g., a Rich Execution Environment (REE)) and a second execution environment (e.g., a Trusted Execution Environment (TEE)). According to an embodiment, the second execution environment (e.g., the TEE) may be an execution environment having a different (e.g., higher) security level than a security level of the first execution environment (e.g., the REE). The plurality of execution environments of the electronic device 100 will be described below in detail with reference to FIG. 2.

According to an embodiment, the memory 110 may store instructions for allowing the processor 130 to process data or to control a component of the electronic device, in order to perform an operation of the electronic device 100, when executed.

According to an embodiment, the memory 110 may include a plurality of applications executed respectively in the plurality of execution environments. For example, the memory 110 may include at least one blockchain application executed in the first execution environment. The blockchain application may include a blockchain application performing a blockchain-related operation and/or a wallet application performing a transaction-related operation in a blockchain network. The blockchain application may include instructions for allowing the processor 130 to control the component of the electronic device 100, in order to perform the blockchain-related operation when executed by the processor 130.

According to an embodiment, the memory 110 may store the blockchain application downloaded through a server by the processor 130 or a user of the electronic device 100. In an embodiment, an application related to a blockchain wallet may perform a blockchain-related function including a function of opening an account used in the blockchain network and transferring or depositing virtual currency.

According to an embodiment, the memory 110 may include a secure memory area requiring a high security level. For example, the memory 110 may include an additional secure memory in a hardware manner or may divide some areas of the memory 110 as the secure memory area. According to an embodiment, the secure memory area may be included in the second execution environment. The secure memory area may store a private key requiring a high security level.

According to an embodiment, the memory 110 may include at least one Trusted Application (TA) executed in the second execution environment. According to an embodiment, the TA may perform an operation utilizing data having a high security level. For example, the TA may execute a digital signature by using the private key of the electronic device 100. For example, the TA may acquire a signature request for a transaction from a blockchain application executed in the first execution environment, and may execute the digital signature for the transaction with the private key in response to the signature request.

According to an embodiment, the display 120 may display a variety of content (e.g., a text, an image, a video, an icon, and/or a symbol, etc.). According to an embodiment, the display 120 may include a Liquid Crystal Display (LCD), a Light Emitting Diode (LED) display, or an Organic Light Emitting Diode (OLED) display. According to an embodiment, the processor 130 may display a variety of content related to the blockchain application through the display 120. For example, the processor 130 may display various execution screens of the blockchain application through the display 120. An execution screen of the blockchain application may include a screen including information on a transaction and/or a screen including information related to the digital signature for the transaction.

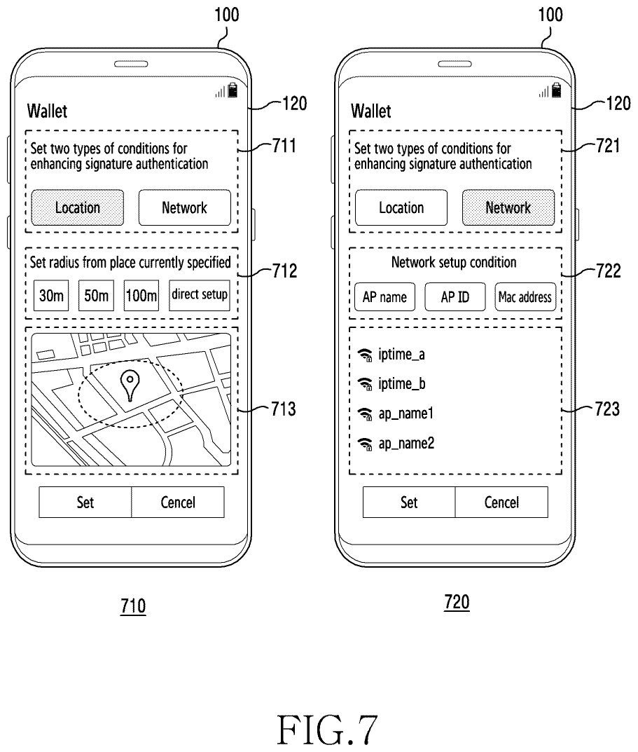

According to an embodiment, the processor 130 may display a screen to set a signature condition for executing the digital signature for the transaction through the display 120, and may receive the signature condition and a user input. For example, the processor 130 may display a screen including condition information for configuring the signature condition through the display 120, and may acquire an input related to the configuring of the signature condition from a user through the display 120. According to various embodiments, content for the screen displayed on the display 120 will be described below with reference to FIGS. 7 to 10.

According to an embodiment, the processor 130 may be electrically or operatively coupled to the memory 110, the display 120, and/or the communication circuit 140. According to an embodiment, the processor 130 may use instructions stored in the memory 110 to control at least one of other components of the electronic device 100 and/or execute an arithmetic operation or data processing for communication. According to an embodiment, the processor 130 may include at least one of a Central Processing Unit (CPU), a Graphics Processing Unit (GPU), a Micro Controller Unit (MCU), a sensor hub, a supplementary processor, a communication processor, an application processor, an Application Specific Integrated Circuit (ASIC), and a Field Programmable Gate Arrays (FPGA), and may have a plurality of cores.

According to an embodiment, in a plurality of execution environments, the processor 130 may execute an application included in each execution environment. For example, the processor 130 may perform an operation related to a blockchain through the blockchain application stored in the memory 110 in the first execution environment (e.g., the REE). In addition, the processor 130 may perform an operation related to the blockchain through a trusted application stored in the memory 110 in the second execution environment (e.g., the TEE). According to an embodiment, the performing of the operation related to the blockchain by the processor 130 may be understood as being executed through the blockchain application or the trusted application.

According to an embodiment, the communication circuit 140 may be configured to transmit/receive data by being coupled to an external device. According to an embodiment, the electronic device 100 may be coupled to the blockchain network through the communication circuit 140. The processor 130 may use a private key to generate signature data by executing the digital signature for the transaction, and may transmit the generated signature data to the blockchain network coupled through the communication circuit 140. Based on the signature data transmitted to the blockchain network, a verification operation and/or a consensus operation for the transaction may be performed through blockchain nodes included in the blockchain network.

According to an embodiment, the electronic device 100 may include the state detection circuit 150. According to an embodiment, the processor 130 may acquire state information for determining and/or configuring the signature condition for the transaction through the state detection circuit 150.

In an embodiment, the state detection circuit 150 may generate a variety of state data related to the signature condition. For example, the state detection circuit 150 may use a location sensor (e.g., a Global Navigation Satellite System (GNSS) module) for determining location information to generate location data of the electronic device 100. According to various embodiments, a location sensor may represent various configurations for determining a location of the electronic device 100 without being limited to an expression. According to an embodiment, when the state detection circuit 150 is configured to determine location information, the state detection circuit 150 may be included in the communication circuit 140. In addition, the state detection circuit 150 may use a sensor (e.g., a touch sensor) for acquiring a touch input to generate touch data acquired by the electronic device 100. In addition, the state detection circuit 150 may generate connection data for an external electronic device which has established various network connections (e.g., Bluetooth, Wireless Fidelity (Wi-Fi) direct, or Infrared Data Association (IrDA)) with the electronic device 100. According to an embodiment, the state detection circuit 150 may transmit the generated state data to another component of the electronic device 100.

According to an embodiment, the processor 130 may acquire, in the second execution environment, a signature request for a transaction generated through the blockchain application. For example, the processor 130 may execute the blockchain application in the first execution environment, may acquire a transaction generation request through the blockchain application or a different application, and may generate the transaction through the blockchain application. For example, a transaction for transferring or depositing a certain amount of virtual currency to an account of a user of an external electronic device may be generated through the blockchain application. In an embodiment, the processor 130 may transmit the signature request for the transaction generated through the blockchain application to the second execution environment.

According to an embodiment, the processor 130 may acquire, in the second execution environment, first state data through the state detection circuit 150, in response to the signature request. For example, the processor 130 may acquire, in the second execution environment, location data indicating information on a current location of the electronic device 100 through the state detection circuit 150, touch data acquired through a touch sensor of the electronic device 100, and/or connection data indicating connection information with respect to the external electronic device.

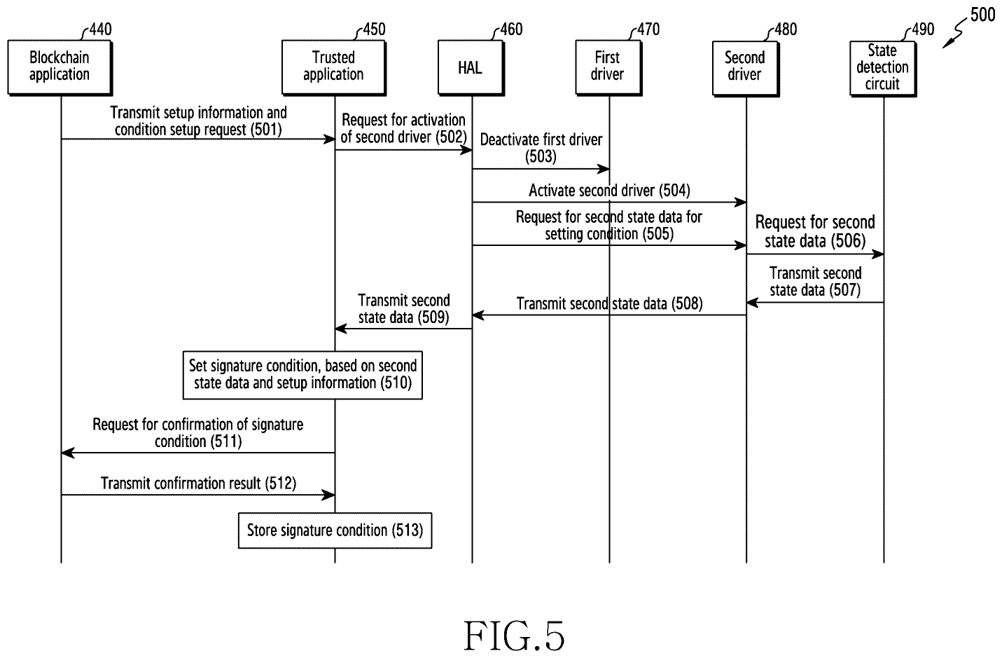

According to an embodiment, the processor 130 may determine whether the first state data acquired through the state detection circuit 150 satisfies the signature condition stored in the second execution environment. According to an embodiment, a secure memory area included in the second execution environment may store a signature condition regarding a condition for executing the digital signature. For example, the second execution environment may set the condition for executing the digital signature and store the set signature condition. An operation of configuring the signature condition will be described below with reference to FIG. 5.

According to an embodiment, the processor 130 may determine whether the first state data acquired through the state detection circuit 150 satisfies the signature condition. For example, the processor 130 may determine whether the location of the electronic device 100 is included in a specified location range through the location data. Alternatively, the processor 130 may determine whether the external electronic device coupled to the electronic device 100 through connection data is a specified external electronic device. Without being limited to the described example, the processor 130 may use various types of state data acquired through the state detection circuit 150 to determine whether various types of signature conditions stored in the second execution environment are satisfied.

According to an embodiment, the processor 130 may generate signate data by executing the digital signature for the transaction with a private key stored in the second execution environment, based on a determination result acquired by determining whether the signature condition is satisfied. For example, when it is determined that the signature condition is satisfied based on the first state data, the processor 130 may execute the digital signature for the transaction with the private key stored in the second execution environment. Therefore, signature data including the transaction electronically signed with the private key may be generated.

According to an embodiment, the processor 130 may transfer the generated signature data to the blockchain application in the first execution environment. For example, the processor 130 may transfer the generated signature data to the first execution environment. The processor 130 may transmit to the blockchain network the signature data including the transaction electronically with the private key by using the blockchain application in the first execution environment.

FIG. 2 illustrates an execution environment of an electronic device according to an embodiment of the disclosure.

Referring to FIG. 2, a plurality of execution environments operated in the electronic device 100 is illustrated. For example, the electronic device 100 may operate in a first execution environment (e.g., a rich execution environment (REE) 210) and a second execution environment (e.g., a TEE 220). However, without being limited to various embodiments disclosed in the disclosure, the electronic device 100 may include an additional execution environment (e.g., a third execution environment) having another security level or other different execution environments, in addition to the first execution environment and the second execution environment. Hereinafter, the first execution environment may be expressed as the REE 210, and the second execution environment may be repressed as the TEE 220. However, without being limited to the expression, the REE 210 may correspond to a normal execution environment, and the TEE 220 may correspond to an execution environment having a higher security level than the normal execution environment.

According to various embodiments, the REE 210 and the TEE 220 may be operated through various methods, without being limited to the example of FIG. 2. According to an embodiment, the electronic device 100 may be operated with the REE 210 and the TEE 220. According to an embodiment, the TEE 220 may be implemented as an additional circuit, and may include an additional processor. The TEE 220 may exist in a detachable smart chip or a Secure Digital (SD) card, or may include an embedded Secure Element (eSE) embedded in a fixed chip of the electronic device 100. In addition, the TEE 220 may be driven by an operating system (e.g., a trusted Operating System (OS) component 226) different from an operating system (e.g., an android OS) of the electronic device 100. For example, it may operate based on a Java Card Open Platform (JCOP) operating system. According to an embodiment, the electronic device 100 may use the single processor 130 and the single memory 110 by dividing them into the REE 210 and the TEE 220 in a hardware manner (e.g., a trust zone of ARM). For example, the electronic device 100 may temporally separate the single processor 130 to be used by dividing it into the REE 210 and the TEE 220. In addition, the electronic device 100 may use the memory 110 by dividing it into an accessible area in the REE 210 and an accessible area in the TEE 220. In addition thereto, various components of the electronic device 100 may be used by being divided into an area of the REE 210 and an area of the TEE 220.

According to an embodiment, the electronic device 100 may implement a processor for operating the REE 210 and a processor for operating the TEE 220 in the form of an on-chip, and may implement each of them as a processing core set. In an embodiment, the processor for the TEE 220 may have the same or similar configuration as the processor 130.

According to an embodiment, since the processor for the REE 210 and the processor for the TEE 220 are implemented as additional hardware chips, the electronic device 100 may include separate chips. For example, it may be configured such that one System on Chip (On-SoC) operates the REE 210, and one or more external security co-processors provided outside the On-SoC may be configured to operate the TEE 220.

According to an embodiment, the REE 210 may include a blockchain application 211 and other various applications (not shown), a blockchain shared memory 212, an REE Application Programming Interface (API) 213, an REE Hardware Abstract Layer (HAL) 214, and/or a general Operating System (OS) component 215.

According to an embodiment, the blockchain application 211 may be an application which performs a blockchain-related operation. For example, the blockchain application may be a wallet application. The blockchain application, for example, an application related to a blockchain wallet, may perform a blockchain-related function including a function of opening an account used in a blockchain network and transferring or depositing virtual currency.

According to an embodiment, the blockchain application 211 may generate a transaction, and may transmit to a trusted application 222 a signature request for the generated transaction. In addition, in response to acquiring, from the trusted application 222, signature data including transaction data electronically signed, the blockchain application 211 may transmit the signature data to the blockchain network (e.g., a mainnet).

According to an embodiment, the blockchain application 211 may acquire a request for configuring a signature condition from a user or a different application, and may transmit configuration information including a condition configuration request and information on a condition to the trusted application 222.

In addition, various applications (e.g., a client application) may include one or more applications capable of performing various functions including phone calls, messaging, payments, alarms, browsers, and/or cameras.

According to an embodiment, the REE 210 may include the blockchain shared memory 212. The processor 130 may use the blockchain shared memory 212 to access a blockchain shared memory view 221 of the TEE 220. The blockchain shared memory 212 may be memory accessible by an application (e.g., the blockchain application 211 and the trusted application 222) of the REE 210 and TEE 220.

The REE API 213 may be an interface in which an application controls a function provided in a kernel or middleware. For example, the REE API 213 may include at least one interface or function (e.g., a command) for various functions including file control, window control, image processing, or character control. The REE API 213 may be provided in different configurations depending on an operating system, as a set of programming functions. For example, in case of Android or IOS, one API set may be provided for each platform. In case of Tizen, two or more API sets may be provided for each platform. According to an embodiment, the REE API 213 may include a functional API allowed to access the TEE 220. For example, the REE API 213 may include an application interface designed to access some services of the TEE 220. The REE API 213 may include an interface designed to exchange data between applications of the REE 210 and TEE 220.

According to an embodiment, the REE 210 may include the REE HAL 214. According to an embodiment, the REE HAL 214 may represent an aggregation of routines which handle hardware-dependent details required to implement input/output interfaces, interrupt controls, and processor communication. For example, the REE HAL 214 may receive an abstracted control command or request from the blockchain application 211, and may transfer the received control command or request to a device driver included in the general OS component 215. According to an embodiment, the REF HAL 214 may transfer the abstracted control command or request acquired from the blockchain application 211 to operate in accordance with the device driver included in the general OS component 215. For example, the REE HAL 214 may transfer the control command acquired to activate or deactivate the device driver included in the general OS component 215 in accordance with the abstracted control command acquired from the blockchain application 211. In an embodiment, the device driver may transmit the received control command to the state detection circuit 150. For example, the REE HAL 214 may transfer the command to the general OS component 215 to deactivate the device driver included in the general OS component 215, in response to the command related to an operation for the trusted application 222 and received from the blockchain application 211. In addition, the REE HAL 214 may transfer the received command to the general OS component 215 to activate the device driver, in response to a command related to terminating of the operation for the trusted application 222 from the blockchain application 211.

According to an embodiment, the general OS component (e.g., rich OS component) 215 may include a first touch driver 216, a first location sensor driver 217, and/or a first connection driver 218. According to various embodiments, the general OS component 215 may include various device drivers corresponding to components included in the state detection circuit 150. According to an embodiment, the device driver included in the general OS component 215 may be a system driver for driving the state detection circuit 150 in the REE 210. For example, the first touch driver 216 may be a system driver for driving a touch screen 231. In addition, the first location sensor driver 217 may be a system driver for driving a location sensor (e.g., a GNSS module) 232. In addition, the first connection driver 218 may be a system driver for driving a connection chipset 233.

According to various embodiments, the REE 210 may include other various components. For example, the REE 210 may include an REE communication agent (not shown) which is responsible for handling message communication between the blockchain application 211 and the trusted application 222. The blockchain application 211 may transfer a message from the REE communication agent to a TEE communication agent (not shown) of the TEE 220 by using the REE API 213. In this case, the message may be implemented in a hardware manner so as to be transmitted only to the TEE 220.

The TEE 220 may store data requiring a relatively higher security level than the REE 210 in a reliable environment, and may perform a related operation. The TEE 220 may operate on an application processor of the electronic device 100, and may operate based on a reliable hardware structure determined in a manufacturing process of the electronic device 100. The TEE 220 may divide the application processor or memory into a normal area and a secure area, and may operate in the secure area. The TEE 220 may be configured to operate software or hardware requiring security only in the secure area. The electronic device 100 may operate the TEE 220 through a hardware physical change or a software logical change. The TEE 220 may be separated from the REE 210 through a hardware constraint, and may operate by being separated from the same hardware in a software manner.

The TEE 220 may include the blockchain shared memory view 221, the trusted application 222, a secure memory 223, a TEE API 224, a TEE HAL 225, and/or the trusted operating system component (e.g., the trusted OS component) 226. The blockchain shared memory view 221 may be memory space accessible to the blockchain shared memory 212 of the REE 210.

According to an embodiment, the trusted application 222 may include one or more applications capable of performing various functions requiring a high security level such as Digital Rights Management (DRM), security, payment, or biometric information usage. The trusted application 222 may perform an operation based on a request acquired from the REE 210, and may transfer an operation processing result to the REE 210.

According to an embodiment, the trusted application 222 may acquire a private key generation request from the blockchain application 211 and/or other different applications. According to an embodiment, the processor 130 may execute the trusted application 222 to generate a key-pair including a primary key and a public key. In addition, the trusted application 222 may store the generated private key in the secure memory 223. According to an embodiment, the trusted application 222 may generate a root seed, and may generate the private key and the public key, based on the generated root seed. In an embodiment, the root seed may mean a seed value randomly generated in a condition within a range available in the blockchain network. According to an embodiment, the root seed may generate a master private key and a master chain code from a hash value generated through a Hash-based Message Authentication Code (HMAC)-Secure Hash Algorithm (SHA)-512 algorithm function. In a hashed value of 512 bits, left 256 bits may be used as a private key, and right 256 bits may be used as a chain code. A public key may be acquired by using the private key and an elliptic curve function. However, the aforementioned description on the root seed and the key is only an example, and the disclosure is not limited thereto. According to various embodiments, the trusted application 222 may generate a root seed in various manners (e.g., TRNG), and may derive a key-pair from the root seed.

According to an embodiment, the trusted application 222 may acquire a condition configuration request for an operation of executing a digital signature with a private key from the blockchain application 211. For example, regarding the executing of the digital signature, the trusted application 222 may acquire through the blockchain application 211 the condition configuration request which allows the electronic device 100 to execute the digital signature only within a specific range (e.g., a radius of 500m) from a specified location. As another example, regarding the executing of the digital signature, the trusted application 222 may acquire through the blockchain application 211 the condition configuration request which allows to execute the digital signature only in a state where a specified external electronic device is connected. According to an embodiment, in response to the condition configuration request, the trusted application 222 may set a signature condition, and may store the set signature condition in the secure memory 223. For example, the trusted application 222 may acquire the condition configuration request and configuration information (e.g., within a specified location radius of 500m) through the blockchain application 211. In addition, the trusted application 222 may store the signature condition in the secure memory 223, based on the condition configuration request and configuration information. According to various embodiments, when the state detection circuit 150 needs to be used in the configuring of the signature condition, the trusted application 222 may acquire state data from a device driver (e.g., a second touch driver 227, a second location sensor driver 228, and/or a second connection driver 229) included in the trusted OS component 226. The trusted application 222 may set the signature condition, based on the state data and configuration information, and may store the configured condition signature in the secure memory 223.

According to an embodiment, the trusted application 222 may acquire a digital signature request for a transaction generated from the blockchain application 211. According to an embodiment, the trusted application 222 may acquire state data from the device driver (e.g., the second touch driver 227, the second location sensor driver 228, and/or the second connection driver 229) included in the trusted OS component 226, in response to the signature request for the transaction. For example, in response that the trusted application 222 acquires the digital signature request for the transaction generated from the blockchain application 211, the REE HAL 214 may transfer a control command to the general OS component 215 to deactivate the device driver included in the general OS component 215. In addition, in response to an activation request of the device driver included in the trusted OS component 226 from the trusted application 222, the TEE HAL 225 may transfer a control command to activate the device driver included in the trusted OS component 226. Therefore, the REE HAL 214 and the TEE HAL 225 may provide control such that device drivers included respectively in the REE 210 and the TEE 220 are not simultaneously coupled to the state detection circuit 150.

According to an embodiment, the trusted application 222 may use state data acquired from the state detection circuit 150 to determine whether a signature condition stored in the secure memory 223 is satisfied. For example, the trusted application 222 may use the second location sensor driver 228 to acquire location data indicating information on a current location of the electronic device 100 from the location sensor 232. In addition, the trusted application 222 may determine whether the signature condition (e.g., within a radius of 500m from a specified location) stored in the secure memory 223 is satisfied, based on the acquired location data.

According to an embodiment, the trusted application 222 may transmit the determination result to the blockchain application 211. For example, the trusted application 222 may transmit information on whether the signature condition is satisfied or the signature condition is not satisfied to the blockchain application 211. In addition, the trusted application 222 may execute the digital signature for the transaction through a private key stored in the secure memory 223, in response that the signature condition is satisfied. For example, upon satisfying the signature condition, the trusted application 222 may use the private key to execute the digital signature for the transaction through a digital signature algorithm (e.g., a Rivest, Shamir, Adleman (RSA) algorithm and/or an Elliptic Curve Digital Signature Algorithm (ECDSA)). According to an embodiment, the trusted application 222 may execute the digital signature for the transaction with the private key and transmit the generated signature data to the blockchain application 211.

According to an embodiment, the TEE API 224 may be an interface provided to operate basic software of the TEE 220. According to an embodiment, the trusted application 222 may use the TEE API 224 to receive various request messages transferred from the REE 210. For example, the trusted application 222 may use the TEE API 224 to receive a signature request for a transaction to be generated and/or a signature condition configuration request from the blockchain application 211.

According to an embodiment, the TEE HAL 225 may perform an operation similar to the REE HAL 214. For example, the TEE HAL 225 may receive an abstracted control command or request from the trusted application 222, and may transfer the received control command or request to a device driver included in the trusted OS component 226. According to an embodiment, the TEE HAL 225 may transfer the abstracted control command or request acquired from the trusted application 222 to operate in accordance with the device driver included in the trusted OS component 226. For example, the TEE HAL 225 may transfer the control command acquired to activate or deactivate the device driver included in the trusted OS component 226 in accordance with the abstracted control command acquired from the trusted application 222. In an embodiment, the device driver may transmit the received control command to the state detection circuit 150. For example, the TEE HAL 225 may transfer to the trusted OS component 226 the command received to activate the device driver included in the trusted OS component 226, in response to the abstracted control command received from the trusted application 222. In addition, the tee HAL 225 may transfer to the trusted OS component 226 the control command acquired to activate or deactivate the device driver. In an embodiment, the device driver may transmit to the state detection circuit 150 the control command received from the TEE HAL 225. For example, the TEE HAL 225 may transfer to the device driver the control command to activate the device driver included in the trusted OS component 226 at the request of the trusted application 222. In addition, in response that an operation executed based on the trusted application 222 terminates in the TEE 220, the TEE HAL 225 may receive the abstracted control command from the trusted application 222, and may transfer a command acquired from the trusted OS component 226 to deactivate the device driver.

According to an embodiment, the trusted OS component 226 may include the second touch driver 227, the second location sensor driver 228, and/or the second connection driver 229. According to various embodiments, the trusted OS component 226 may include various device drivers corresponding to components included in the state detection circuit 150. According to an embodiment, the device driver included in the trusted OS component 226 may be a system driver for driving the state detection circuit 150 in the TEE 220. For example, the second touch driver 227 may be a system driver for driving the touch screen 231. In addition, the second location sensor driver 228 may be a system driver for driving the location sensor (e.g., the GNSS module) 232. In addition, the second connection driver 229 may be a system driver for driving the connection chipset 233.

According to an embodiment, the electronic device 100 may be configured such that a single configuration (e.g., the touch screen 231, the location sensor 232, and/or the connection chipset 233) is shared and used for each type included in the state detection circuit 150 by the general OS component 215 and the trusted OS component 226. The single configuration for each type included in the state detection circuit 150 may be configured not to be used by the trusted OS component 226 when used by the general OS component 215, and not to be used by the general OS component 215 when used by the trusted OS component 226. The electronic device 100 may switch and use the configuration included in the state detection circuit 150 through the REE HAL 214 and the TEE HAL 225.

The trusted OS component 226 may include a TEE communication agent (not shown), a trusted core framework (not shown), a trusted function (not shown), and/or a trusted kernel (not shown), in addition to the illustrated component. The TEE communication agent may be responsible for handling reliable message communication between the blockchain application 211 and the trusted application 222, as one type of a framework function API. The trusted core framework may provide various operating system functions such as scheduling, communication, memory management, so as to be performed by the trusted application 222. The trusted function may provide a trusted function such as encryption, and the trusted kernel may be a kernel for driving the TEE 220. In addition, the TEE 220 is not limited to the illustrated configuration, and various configurations may be added or some of the configurations may be omitted. For example, the TEE 220 may include a TEE framework which provides a variety of secure libraries.

According to various embodiments, the blockchain application 211 and/or the trusted application 222 may operate when the processor 130 executes the blockchain application 211 in the first execution environment (e.g., the REE 210) and/or the processor 130 executes the trusted application 222 in the second execution environment (e.g., the TEE 220), respectively. Therefore, the operations of the blockchain application 211 and/or trusted application 222 may be expressed respectively as an operation of the processor 130 in the first execution environment and/or an operation of the processor 130 in the second execution environment.

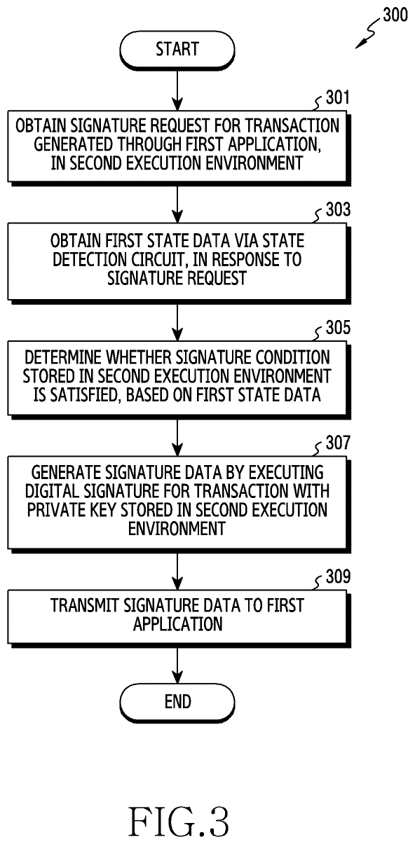

FIG. 3 is a flowchart 300 for explaining an electronic device which executes a digital signature for a transaction according to an embodiment of the disclosure.

Referring to FIG. 3, in operation 301, the processor 130 may acquire, in a second execution environment (e.g., the TEE 220), a signature request for a transaction generated through a first application (e.g., the blockchain application 211).

According to an embodiment, the processor 130 may acquire, in a first execution environment (e.g., the REE 210), a transaction generation request from a user and/or a different application through the blockchain application 211. For example, the processor 130 may acquire, in the first execution environment, a request intending to transmit a certain amount of money from the user to another user through the blockchain application 211. The processor 130 may generate a transaction, in response to the transaction generation request. In an embodiment, the processor 130 may transmit a signature request for the generated transaction to a second application (e.g., the trusted application 222).

According to an embodiment, in operation 303, the processor 130 may acquire first state data through the state detection circuit 150 in response to the signature request. For example, the processor 130 may request, in the second execution environment, the state detection circuit 150 to provide the first state data by using a device driver (e.g., the second touch driver 227, the second location sensor driver 228, and/or the second connection driver 229) included in the second execution environment. In addition, the processor 130 may acquire the first state data from the state detection circuit 150 by using the device driver. For example, the processor 130 may acquire location data indicating location information of the electronic device 100 by using the second location sensor driver 228 through the location sensor 232 in response to the signature request. As another example, the processor 130 may acquire connection data indicating information (e.g., Access Point (AP) information) of an external device currently coupled to the electronic device 100 by using the second connection driver 229 through the connection chipset 233 in response to the signature request.

According to an embodiment, in operation 305, the processor 130 may determine whether a signature condition stored in the second execution environment is satisfied, based on the first state data. According to an embodiment, the processor 130 may determine, in the second execution environment, whether the signature condition stored in the secure memory 223 is satisfied, based on the first state data acquired through the state detection circuit 150. For example, the processor 130 may determine whether the signature condition (e.g., within a radius of 500m from a specified location) is satisfied, based on the location data. As another example, the processor 130 may determine whether the signature condition (e.g., when coupled to a specified external electronic device) is satisfied, based on the connection data.

According to an embodiment, in operation 307, the processor 130 may generate signature data by executing a digital signature for a transaction with a private key stored in the second execution environment. For example, the processor 130 may execute, in the second execution environment, the digital signature for the transaction by using the private key in response that a signature condition is satisfied. As another example, when the signature condition is not satisfied, the processor 130 may terminate a signature operation for the transaction. The processor 130 may transmit to the first application a notification indicating that the signature condition is not satisfied.

According to an embodiment, in operation 309, the processor 130 may transmit the signature data to the first application. For example, when the signature condition is satisfied, the processor 130 may execute the digital signature for the transaction by using a private key stored in the secure memory 223 to generate signature data, and may transmit the generated signature data to the first application. In response to acquiring, from the processor 130, signature data including transaction data electronically signed, the first application may transmit the signature data to a blockchain network (e.g., a mainnet).

According to an embodiment, the operation of the processor 130 in the second execution environment may be performed by executing the second application (e.g., the trusted application 222).

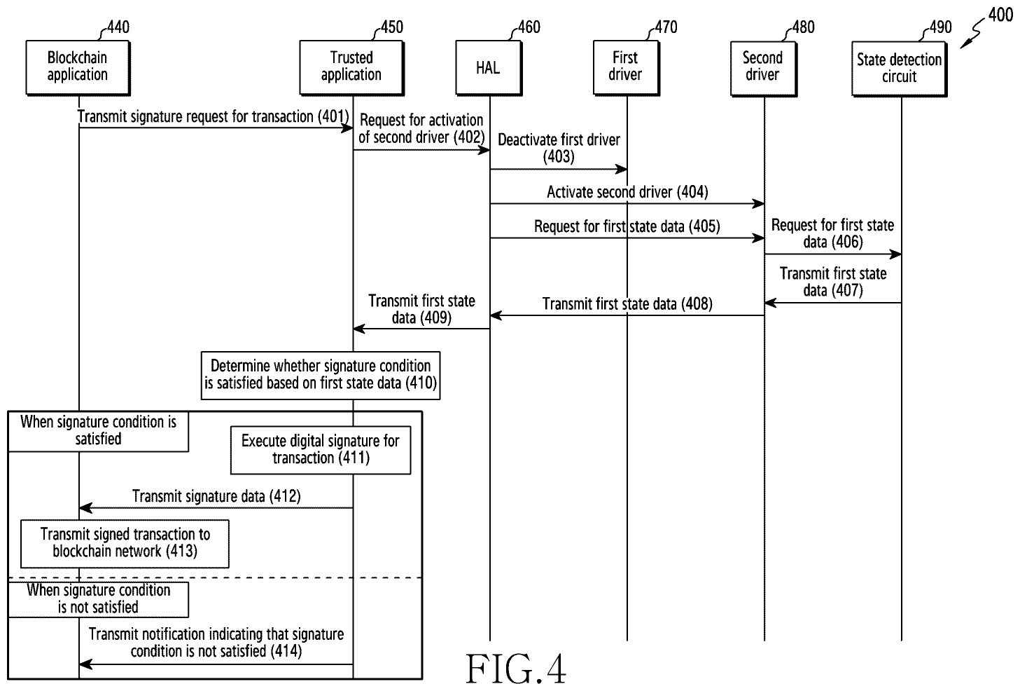

FIG. 4 is a flowchart 400 for explaining an operation of an electronic device which executes a digital signature, based on that a signature condition is satisfied, according to an embodiment of the disclosure.

Referring to FIG. 4, the electronic device 100 may include a blockchain application 440 (e.g., the blockchain application 211 of FIG. 2), a trusted application 450 (e.g., the trusted application 222 of FIG. 2), a Hardware Abstract Layer (HAL) 460, a first driver 470 (e.g., the first touch driver 216, the first location sensor driver 217, and/or the first connection driver 218), a second driver 480 (e.g., the second touch driver 227, the second location sensor driver 228, and/or the second connection driver 229), and/or a state detection circuit 490 (e.g., the state detection circuit 150 of FIG. 1).

According to an embodiment, in FIGS. 4 and 5 described below, the HAL 460 may include the REE HAL 214 and TEE HAL 225 described with reference to FIG. 2. Hereinafter, an operation of the HAL 460 may represent an operation of the REE HAL 214 or TEE HAL 225 according to an execution environment. For example, when the processor 130 operates in the first execution environment (e.g., the REE 210 of FIG. 2) and performs an operation for the first driver 470, the operation of the HAL 460 may represent the operation of the REE HAL 214. In addition, when the processor 130 operates in the second execution environment (e.g., the TEE 220 of FIG. 2) and performs an operation for the second driver 480, the operation of the HAL 460 may represent the operation of the TEE HAL 225.

According to an embodiment, the operation of the blockchain application 440 may represent an operation performed when the processor 130 executes the blockchain application 440 in the first execution environment (e.g., the REE 210 of FIG. 2). Therefore, hereinafter, the operation of the blockchain application 440 may be expressed as an operation of the processor 130 in the first execution environment. According to an embodiment, the operation of the trusted application 450 may represent an operation performed when the processor 130 executes the trusted application 450 in the second execution environment (e.g., the TEE 220 of FIG. 2). Therefore, hereinafter, the operation of the trusted application 450 may be expressed as an operation of the processor 130 in the second execution environment.

According to an embodiment, the blockchain application 440 may generate a transaction in the first execution environment. In an embodiment, the blockchain application 440 may transmit a signature request for the transaction to the trusted application 450 (see 401). According to an embodiment, the processor 130 may execute the blockchain application 440 to generate the transaction, and may transmit a signature request for the generated transaction to the trusted application 450.

According to an embodiment, in response to acquiring of the signature request for the transaction, the trusted application 450 may request the HAL 460 to activate the second driver 480 (see 402). For example, the trusted application 450 may request the HAL 460 to activate the second driver 480, in order to use the state detection circuit 490.

According to an embodiment, in response to the request 402, the HAL 460 may deactivate the first driver 470 (see 403). In addition, the HAL 460 may activate the second driver 480 (see 404). For example, the HAL 460 may control the first driver 470 to deactivate the first driver 470. In addition, the HAL 460 may control the second driver 480 to activate the second driver 480.

According to an embodiment, the HAL 460 may request the second driver 480 for first state data (see 405). For example, in response to the second driver activation request 402 from the trusted application 450, the HAL 460 may request the second driver 480 for the first state data (see 405). Alternatively, in order to determine whether a signature for a transaction is satisfied, the HAL 460 may request the second driver 480 for the first state data (see 405).

According to an embodiment, in response to the request 405, the second driver 480 may request the state detection circuit 490 for the first state data (see 406). For example, in response to the request 405, the second driver 480 (e.g., the second location sensor driver 228) may request the state detection circuit 490 (e.g., the location sensor 232) for the first state data (e.g., location data).

According to an embodiment, in response to the request 406, the state detection circuit 490 may transmit the first state data (see 407). For example, the state detection circuit 490 may use a location sensor (e.g., a GNSS sensor) for determining location information of the electronic device 100 to generate location data of the electronic device 100. For example, the state detection circuit 490 may use the location sensor to generate latitude and/or longitude data. The state detection circuit 490 may transmit the generated location data to the second driver 480. As another example, the state detection circuit 490 may generate connection data representing information of an external electronic device coupled to the electronic device 100. For example, the state detection circuit may generate name, identification data (e.g., ID), and/or Medium Access Control (MAC) address data of the external electronic device. The state detection circuit 490 may transmit the generated connection data to the second driver 480.

According to an embodiment, the second driver 480 may transmit to the HAL 460 the first state data acquired from the state detection circuit 490 (see 408). The HAL 460 may transmit the first state data to the trusted application 450 (see 409). Through the operations 407 to 409, the trusted application 450 may acquire the first state data from the state detection circuit 490.

According to an embodiment, the trusted application 450 may determine whether a signature condition is satisfied based on the first state data (see 410). For example, the trusted application 450 may determine whether the signature condition stored in the second execution environment (e.g., the secure memory 223) is satisfied based on the first state data. For example, the trusted application 450 may determine whether the electronic device 100 is located within a radius of 500m from a specified location, based on location data acquired from the state detection circuit 490. As another example, the trusted application 450 may determine whether the electronic device 100 is coupled to a specified external electronic device, based on connection data acquired from the state detection circuit 490.

According to an embodiment, when the signature condition is satisfied, the trusted application 450 may execute the digital signature for the transaction (see 411). For example, the trusted application 450 may use a private key stored in the secure memory 223 to generate signature data for the transaction.

According to an embodiment, the trusted application 450 may transmit to the blockchain application 440 the signature data generated in the operation 411 (see 412).

According to an embodiment, the blockchain application 440 may transmit the signed transaction to a blockchain network (see 413). For example, the blockchain application 440 may transmit transaction data electronically signed with a private key of the electronic device 100 to the blockchain network. According to an embodiment, the electronic device 100 may add data related to the signature condition to the transaction electronically signed. For example, the electronic device 100 may add information on the signature condition and/or first state data to transaction data. According to an embodiment, the electronic device 100 and/or blockchain nodes (e.g., external electronic devices) included in the blockchain network may add the first state data to the transaction data and, when necessary, may search for block data to confirm state data. According to an embodiment, the electronic device 100 may generate and utilize a smart contract which requires satisfaction of the signature condition. For example, the electronic device 100 may execute the smart contract when the signature condition is satisfied, and may generate the smart contract which terminates the execution of the smart contract when the signature condition is not satisfied.

According to an embodiment, the blockchain application 440 may display a screen related to the execution of the transaction through the display 120 upon satisfying the signature condition. For example, the blockchain application 440 may display through the display 120 a screen including information on the generated transaction and/or a screen indicating that the signed transaction has been transmitted to the blockchain network.

According to an embodiment, when the signature condition is not satisfied, the trusted application 450 may transmit to the blockchain application 440 a notification indicating that the signature condition is not satisfied (see 414). According to an embodiment, the blockchain application 440 may display through the display 120 a screen indicating that the digital signature for the transaction has not been executed since the signature condition is not satisfied.

According to an embodiment, the trusted application 450 and/or the blockchain application 440 may terminate the operation for the transaction, in response that the signature condition is not satisfied.

FIG. 5 is a flowchart 500 for explaining an operation of an electronic device which sets a signature condition according to an embodiment of the disclosure.

The same description as that described with reference to FIG. 4 may be omitted.

Referring to FIG. 5, according to an embodiment, the blockchain application 440 may acquire a request for configuring a signature condition for a transaction from a user or a different application. For example, the blockchain application 440 may display a User Interface (UI) for setting the signature condition through the display 120, and may acquire a configuration request and configuration information of the signature condition through the user and/or the different application. For example, the blockchain application 440 may acquire the configuration request of the signature condition allowing a signature to be executable only when located within a radius of 500m from a specified location. In addition, the blockchain application 440 may acquire configuration information including information on the specified location.

According to an embodiment, the blockchain application 440 may transmit the configuration information and the condition configuration request to the trusted application 450 (see 501). For example, the blockchain application 440 may transmit to the trusted application 450 the configuration request of the signature condition, which allows the signature to be executable only when the electronic device 100 is located within the radius 500m from the specified location, and the configuration information including information on the specified location.

According to an embodiment, the trusted application 450 may set the signature condition, based on the configuration information and the condition configuration request. In an embodiment, the trusted application 450 may store the signature condition in a second execution environment (e.g., the TEE 220). For example, the trusted application 450 may store the signature condition in the secure memory 223.

According to an embodiment, the trusted application 450 may set the signature condition by using the state detection circuit 490 in the second execution environment. For example, when the configuration condition is the condition for allowing a signature to be executed within a radius of 500m from a location of the electronic device 100, the trusted application 450 may use the state detection circuit 490 to acquire location data (e.g., the second state data) of the electronic device 100. According to an embodiment, in response to acquiring of the signature configuration request, the trusted application 450 may request the HAL 460 to activate the second deriver (see 502). For example, the trusted application 450 may request the HAL 460 to activate the second driver 480, in order to use the state detection circuit 490.

According to an embodiment, in response to the request 502, the HAL 460 may deactivate the first driver 470 (see 503). In addition, the HAL 460 may activate the second driver 480 (see 504). For example, the HAL 460 may control the first driver 470 to deactivate the first driver 470. In addition, the HAL 460 may control the second driver 480 to activate the second driver 480.

According to an embodiment, the HAL 460 may request the second driver 480 for second state data for configuring a condition (see 505). For example, in response to the second driver activation request 504 from the trusted application 450, the HAL 460 may request the second driver 480 for the second state data (see 505).

According to an embodiment, in response to the request 505, the second driver 480 may request the state detection circuit 490 for the second state data (see 506). For example, in response to the request 505, the second driver 480 (e.g., the second location sensor driver 228) may request the state detection circuit 490 (e.g., the location sensor 232) for the second state data (e.g., location data).

According to an embodiment, in response to the request 506, the state detection circuit 490 may transmit the second state data (see 507). For example, the state detection circuit 490 may use a location sensor (e.g., a GNSS sensor) for determining location information to generate location data of the electronic device 100. The state detection circuit 490 may transmit the generated location data to the second driver 480.

According to an embodiment, the second driver 480 may transmit to the HAL 460 the second state data acquired from the state detection circuit 490 (see 508). The HAL 460 may transmit the second state data to the trusted application 450 (see 509). Through the operations 507 to 509, the trusted application 450 may acquire the second state data from the state detection circuit 490.

According to an embodiment, the trusted application 450 may set a signature condition, based on the second state data and the configuration information (see 510). For example, when the configuration information is for configuring the signature condition within a radius of 500m from the location of the electronic device 100, the trusted application 450 may calculate the location within the radius of 500m, based on the second state data (e.g., the location data of the electronic device 100). According to an embodiment, the trusted application 450 may set the calculated location as the signature condition.

According to an embodiment, the trusted application 450 may request the blockchain application 440 to confirm the signature condition (see 511). For example, in order to confirm whether a set signature condition conforms to an intended signature condition, the trusted application 450 may request for the confirming of the signature condition (see 511). According to an embodiment, in response to the request 511, the blockchain application 440 may transmit a confirmation result to the trusted application 450 (see 512). For example, in response to the request 511, the blockchain application 440 may display a screen related to the set signature condition through the display 120. According to an embodiment, the blockchain application 440 may acquire a response for the signature condition set through a user and/or a different application. For example, the blockchain application 440 may display a screen indicating a location within 500m from the location of the electronic device 100 through the display 120, and may display a screen requesting the user for the confirmation through the display 120. The blockchain application 440 may acquire a response on the screen, and may transmit the confirmation result to the trusted application 450 (see 512).

According to an embodiment, the trusted application 450 may store the signature condition (see 513). For example, the trusted application 450 may store the signature condition in the second execution environment (e.g., the secure memory 223).

According to various embodiments, the electronic device 100 may perform operations by skipping some of the operations described with reference to FIGS. 4 and 5. Alternatively, the electronic device 100 may perform operations by adding some operations described with reference to FIGS. 4 and 5.

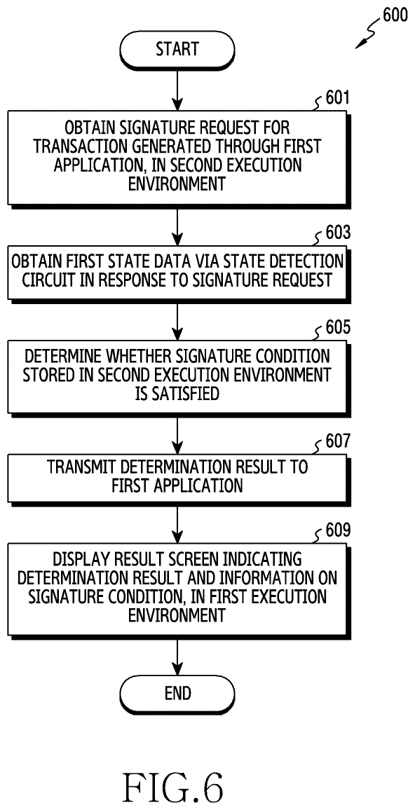

FIG. 6 is a flowchart 600 for explaining an operation of displaying a screen indicating whether an electronic device satisfies a signature condition according to an embodiment of the disclosure.

Referring to FIG. 6, in operation 601, the processor 130 may acquire, in a second execution environment, a signature request for a transaction generated through a first application. For example, the processor 130 may acquire, in the second execution environment (e.g., the TEE 220), the signature request for the transaction generated through the first application (e.g., the blockchain application 211).

According to an embodiment, the processor 130 may acquire, in a first execution environment (e.g., the REE 210), a transaction generation request from a user and/or a different application through the blockchain application 211. For example, the processor 130 may acquire, in the first execution environment, a request intending to transmit a certain amount of money from the user to another user through the blockchain application 211. The processor 130 may generate a transaction, in response to the transaction generation request. In an embodiment, the processor 130 may transmit a signature request for the generated transaction to a second application (e.g., the trusted application 222).

According to an embodiment, in operation 603, the processor 130 may acquire first state data through the state detection circuit 150 in response to the signature request. For example, the processor 130 may request, in the second execution environment, the state detection circuit 150 to provide the first state data by using a device driver (e.g., the second touch driver 227, the second location sensor driver 228, and/or the second connection driver 229) included in the second execution environment. In addition, the processor 130 may acquire the first state data from the state detection circuit 150 by using the device driver. For example, the processor 130 may acquire location data indicating location information of the electronic device 100 by using the second location sensor driver 228 through the location sensor 232 in response to the signature request. As another example, the processor 130 may acquire connection data indicating information (e.g., Access Point (AP) information) of an external device currently coupled to the electronic device 100 by using the second connection driver 229 through the connection chipset 233 in response to the signature request.

According to an embodiment, in operation 605, the processor 130 may determine whether a signature condition stored in the second execution environment is satisfied, based on the first state data. According to an embodiment, the processor 130 may determine whether the signature condition stored in the secure memory 223 is satisfied, based on the first state data acquired through the state detection circuit 150, in the second execution environment. For example, the processor 130 may determine whether the signature condition (e.g., within a radius of 500m from a specified location) is satisfied, based on the location data. As another example, the processor 130 may determine whether the signature condition (e.g., when coupled to a specified external electronic device) is satisfied, based on the connection data.

According to an embodiment, in operation 607, the processor 130 may transmit the determination result to the first application. For example, when the signature condition is satisfied, the processor 130 may execute a digital signature for a transaction by using a private key to generate signature data. In addition, the processor 130 may transmit the generated signature data to the first application. As another example, when the signature condition is not satisfied, the processor 130 may transmit to the first application a notification indicating that the signature condition is not satisfied.

According to an embodiment, in operation 609, the processor 130 may display a result screen indicating the determination result and information on the signature condition in the first execution environment. For example, the processor 130 may display through the display 120 the result screen indicating the determination result and which signature condition it is.

According to an embodiment, when the signature condition is satisfied, the processor 130 may control the display 120 to display a result screen indicating that the digital signature for the transaction has been executed since a certain signature condition is satisfied. Alternatively, when the signature condition is satisfied, the processor 130 may control the display 120 to display a result screen indicating that the transaction has been executed.

According to an embodiment, when the signature condition is not satisfied, the processor 130 may control the display 120 to display a result screen indicating which signature condition is not satisfied. For example, the processor 130 may control the display 120 to display a screen indicating that a location condition is not satisfied, a screen indicating that a connection condition is not satisfied, and/or a screen indicating that a transfer amount is limited at a specified location.

FIG. 7 illustrates a UI for executing a blockchain application according to an embodiment of the disclosure.

Referring to FIG. 7, the electronic device 100 may display an execution screen of the blockchain application 211 through the display 120. According to an embodiment, the processor 130 may control the display 120 to display a location setup screen 710 and/or a connection setup screen 720 among the execution screens of the blockchain application 211. For example, the processor 130 may display a condition configuration screen corresponding to a user input among the execution screens of the blockchain application 211 through the display 120.

According to an embodiment, the processor 130 may display condition type information (e.g., first condition information 711, second condition information 721) including a visual object indicating a location or a network, as a signature condition for a transaction.

According to an embodiment, when a condition based on a location is selected as the signature condition for the transaction, the location setup screen 710 may be displayed through the display 120. For example, the location setup screen 710 may display the type information of the signature condition for the transaction, and may include the first condition information 711 indicating that a location condition is selected. According to an embodiment, the location setup screen 710 may include location selection information 712 for setting the location condition. For example, the processor 130 may display the location selection information 712 for setting the location condition through the display 120, and may acquire an input for the location selection information 712 from a user of the electronic device 100. For example, the location selection information 712 may include visual objects corresponding to 30m, 50m, 100m, and/or direct setup from a specified place. The processor 130 may acquire a user input for the visual objects, and may set the location condition, based on the acquired input. According to various embodiments, the location selection information 712 is not limited thereto, and may include a variety of information for a location to be selected as the signature condition for the transaction.

According to an embodiment, the processor 130 may display a map screen 713 corresponding to a location to be used as the signature condition for the transaction, based on a user input for the location selection information 712. For example, the processor 130 may display through the display 120 the map screen 713 including a visual object for a current location and a visual object for a location (e.g., a radius of 30m) selected from the location selection information 712. According to various embodiments, without being limited to the map screen 713, the processor 130 may display through the display 120 a variety of image information visually indicating information on a location determined as the signature condition for the transaction.

According to an embodiment, when a condition based on a device coupled to the electronic device 100 is selected as the signature condition for the transaction, the connection setup screen 720 may be displayed through the display 120. For example, the connection setup screen 720 may display the type information of the signature condition for the transaction, and may include the second condition information 721 indicating that a connection condition is selected. According to an embodiment, the connection setup screen 720 may include a network setup condition 722 for setting the connection condition. For example, the processor 130 may display the network setup condition 722 for selecting the network setup condition with respect to a device coupled to the electronic device 100 as the signature condition for the transaction through the display 120. In addition, the processor 130 may acquire an input for the network setup condition 722 from a user of the electronic device 100. For example, the network setup condition 722 may include visual objects corresponding to an AP name, an AP ID, and/or a Media Access Control (Mac) address. The processor 130 may acquire a user input for the visual objects, and may set the network setup condition, based on the acquired input. According to various embodiments, the network setup condition 722 is not limited thereto, and may include a variety of information for selecting a connection device to be selected as the signature condition for the transaction.

According to an embodiment, the processor 130 may display a connection device list 723 corresponding to a network setup to be used as the signature condition for the transaction, based on the network setup condition 722. For example, the processor 130 may display through the display 120 the connection device list 723 including the visual object for the selected network setup condition 722.

According to various embodiments, without being limited to the connection device list 723, the processor 130 may display through the display 120 a variety of image information visually indicating information on a network condition determined as the signature condition for the transaction. For example, when the user input for the network setup condition 722 corresponds to an AP name, the processor 130 may display the connection device list 723 including an AP list through the display 120. In addition, the connection device list 723 may include an input field in which a user is able to directly input a connection device.

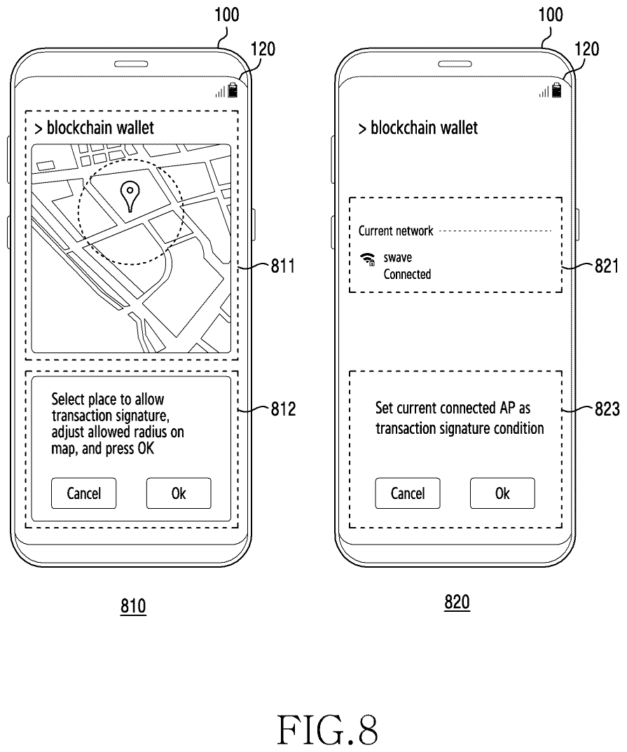

FIG. 8 illustrates a UI for setting a signature condition according to an embodiment of the disclosure.

Referring to FIG. 8, as part of an execution screen of the blockchain application 211, a location condition determining screen 810 and a connection condition determining screen 820 are illustrated according to a type of the signature condition. According to an embodiment, the processor 130 may display a UI for configuring the signature condition through the display 120. For example, when the signature condition is a location-based condition, the processor 130 may display the location condition determining screen 810 through the display 120. According to an embodiment, the location condition determining screen 810 may include a visual object indicating map information 811 and location setup information 812. According to an embodiment, the connection condition determining screen 820 may include a visual object indicating connection network information 821 and connection setup information 823.

According to an embodiment, the processor 130 may display a screen for determining the signature condition through the display 120, in response to a request for configuring the signature condition acquired through the blockchain application 211. For example, when the request for configuring the signature condition based on the location is acquired, the processor 130 may display the location condition determining screen 810 including the map information 811 indicating a current location or a specified location. According to an embodiment, the location condition determining screen 810 may include the location setup information 812. For example, the location condition determining screen 810 may include the location setup information 812 including a phrase for guiding the location condition determination such as “Select a point to allow a transaction signature, adjust an allowable radius on the map, and press OK” or a similar phrase. In an embodiment, the processor 130 may acquire a response to the location setup information 812 through the display 120, and may transmit a signature condition configuration request and location setup information to the trusted application 222.

According to an embodiment, when the signature condition configuration request based on a connection with an external electronic device is acquired, the processor 130 may display the connection condition determining screen 820 including the connection network information 821 indicating information of a currently coupled external electronic device. According to an embodiment, the connection condition determining screen 820 may include the connection network information 821 and the connection setup information 823. For example, the connection condition determining screen 820 may include the connection setup information 823 including a phrase “The currently connected AP is set as the transaction signature condition” or a similar phrase. In an embodiment, the processor 130 may acquire a response for the connection setup information 823 through the display 120, and may transmit the signature condition configuration request and configuration information to the trusted application 222.

According to an embodiment, the processor 130 may perform an operation of determining the signature condition described with reference to FIG. 5, and may display the location condition determining screen 810 and the connection condition determining screen 820 through the display 120, based on second state data acquired from the state detection circuit 150. According to various embodiments, the processor 130 may configure various signature conditions, without being limited to an embodiment disclosed in the disclosure. In addition, the processor 130 may display a screen for determining the various signature conditions through the display 120.

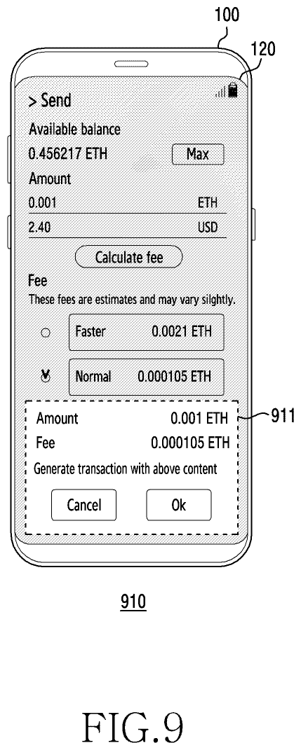

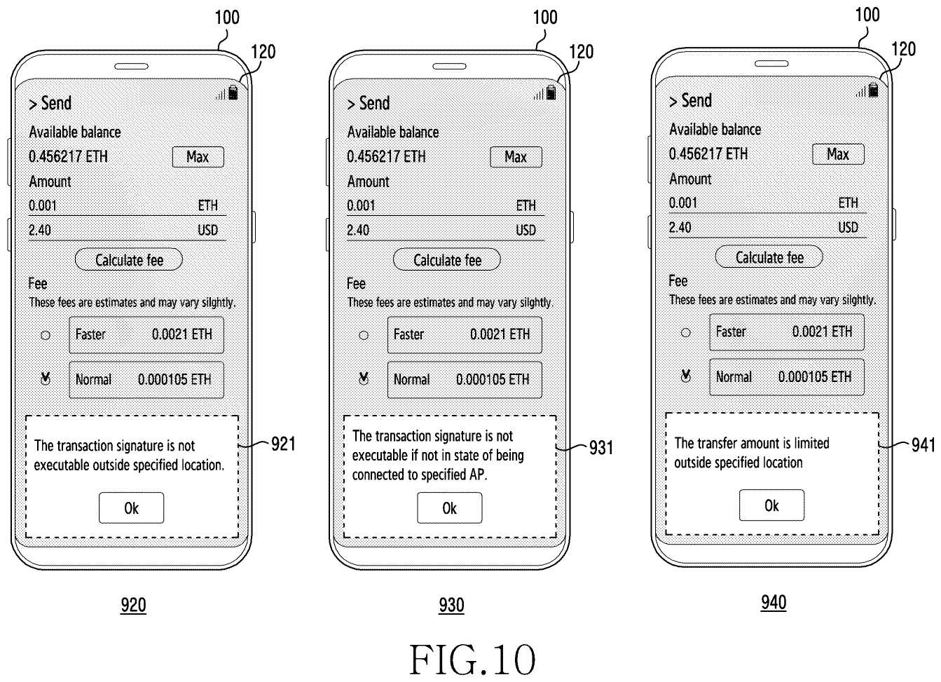

FIG. 9 illustrates a UI for generating a transaction according to an embodiment of the disclosure. FIG. 10 illustrates a result UI on whether a signature condition is satisfied according to an embodiment of the disclosure.

Referring to FIG. 9, a transaction generating screen 910 is illustrated through the blockchain application 211.

Referring to FIG. 10, among the various result UIs on whether the transaction signature conditions are satisfied, a first screen 920 for a signature condition based on a location, a second screen 930 for a signature condition based on a coupled external electronic device, and a third screen 940 for a signature condition based on a location and a transfer amount are illustrated.

According to an embodiment, the processor 130 may execute the blockchain application 211, and may display an execution screen of the blockchain application 211 through the display 120. For example, the processor 130 may generate a transaction through the blockchain application 211, and may display the transaction generating screen 910 including information on the generated transaction through the display 120. According to an embodiment, the transaction generating screen 910 may represent a screen for transferring blockchain currency (e.g., 0.001 Ethereum (ETH)). According to an embodiment, when transaction generation is requested based on a user or a different application, the processor 130 may display the transaction generating screen 910 including information 911 on the transaction through the display 120. For example, the information 911 on the transaction may include a transfer amount, a transfer account, and/or a fee.

According to an embodiment, when the transaction is generated through the blockchain application 211, the processor 130 may perform an operation of determining whether the signature condition described with reference to FIG. 4 is satisfied. According to an embodiment, the processor 130 may display through the display 120 a determination result screen as a result of determining whether the signature condition is satisfied.

According to an embodiment, the processor 130 may display through the display 120 the determination result screen, based on the type of the signature condition. For example, the processor 130 may display through the display 120 the first screen 920 for a signature condition based on a location, the second screen 930 for a signature condition based on a coupled external electronic device, and the third screen 940 for a signature condition based on a location and a transfer amount.

According to an embodiment, the processor 130 may acquire through the state detection circuit 150 the first state data to determine whether the signature condition described with reference to FIG. 4 is satisfied, and may determine whether the signature condition stored in the secure memory 223 is satisfied based on the acquired first state data. According to an embodiment, the processor 130 may determine, in a second execution environment, whether the signature condition is satisfied through the trusted application 222, and may transmit the determination result to the blockchain application 211.

According to an embodiment, the processor 130 may display, in a first execution environment, a determination result screen, based on the determination result acquired through the blockchain application 211. For example, when the signature condition is satisfied, the processor 130 may display through the display 120 a screen indicating that the transaction has been executed or a screen indicating that the signature condition is satisfied.

As another example, when the signature condition is not satisfied, the processor 130 may display through the display 120 a screen for the signature condition not satisfied. According to an embodiment, the processor 130 may display the determination result screen for the signature condition, based on the type of the signature condition.

According to an embodiment, when the signature condition is the signature condition based on the location, the processor 130 may display the first screen 920 through the display 120. In an embodiment, the first screen 920 may include first determination result information 921. For example, the processor 130 may display through the display 120 the first determination result information 921 including a phrase “The transaction signature is not executable outside the specified location” or a similar phrase.

According to an embodiment, when the signature condition is the signature condition based on the connection with the external electronic device, the processor 130 may display the second screen 930 through the display 120. In an embodiment, the second screen 930 may include second determination result information 931. For example, the processor 130 may display through the display 120 the second determination result information 931 including a phrase “The transaction signature is not executable if not in a state of being connected to the specified AP” or a similar phrase.

According to an embodiment, when the signature condition is a signature condition based on a location and a transfer amount, the processor 130 may display the third screen 940 through the display 120. In an embodiment, the third screen 940 may include third determination result information 941. For example, the processor 130 may display the third determination result information 941 including “The transfer amount is limited outside a specified location” or a similar phrase through the display 120.

According to various embodiments, the processor 130 may output information included in the screen illustrated in FIGS. 7 to 10 or similar information by using various output devices (e.g., a speaker) without being limited to the display 120.

As described above, an electronic device (e.g., the electronic device 100 of FIG. 1) according to an embodiment may include a display (e.g., the display 120 of FIG. 1), a communication circuit (e.g., the communication circuit 140 of FIG. 1), memory (e.g., the memory 110 of FIG. 1) storing computer-executable instructions including a first application for execution in a first execution environment and a second application for execution in a second execution environment, a state detection circuit (e.g., the state detection circuit 150 of FIG. 1), and at least one processor (e.g., the processor 130 of FIG. 1) communicatively coupled to the state detection circuit, the memory, the communication circuit, and the display, and configured to execute at least one of the first application in the first execution environment or the second application in the second execution environment. The computer-executable instructions, when executed by the at least one processor, may cause the electronic device to acquire, in the second execution environment, a signature request for a transaction generated through the first application, acquire first state data through the state detection circuit in response to the signature request, determine, based on the first state data, whether a signature condition stored in the second execution environment is satisfied, generate, based on the determination result, signature data by executing a digital signature for the transaction with a private key stored in the second execution environment, and transmit the signature data to the first application.

According to an embodiment, the computer-executable instructions, when executed by the at least one processor, may further cause the electronic device to display, in the first execution environment, a result screen indicating whether the signature condition is satisfied through the display, based on the determination result.

According to an embodiment, the computer-executable instructions, when executed by the at least one processor, may further cause the electronic device to display, in the first execution environment, a result screen indicating that the signature condition is not satisfied through the display, in response to a determination that the signature condition is not satisfied, and terminate an operation for the transaction.

According to an embodiment, the computer-executable instructions, when executed by the at least one processor, may further cause the electronic device to acquire, in the first execution environment, a configuration request for setting the signature condition and configuration information for the signature condition through the first application, transmit the configuration request and the configuration information to the second application, set, in the second execution environment, the signature condition, based on the configuration information, according to the acquired configuration request, and store the signature condition in the second execution environment.

According to an embodiment, the computer-executable instructions, when executed by the at least one processor, may further cause the electronic device to acquire, in the second execution environment, second state data based on the configuration information from the state detection circuit. The signature condition may be set based on the configuration information and the second state data.

According to an embodiment, the computer-executable instructions, when executed by the at least one processor, may further cause the electronic device to transmit, in the second execution environment, a confirm request for the signature condition to the first application, display, in the first execution environment, a screen indicating the confirm request through the display by using the first application, and acquire a response for the confirm request by using the first application.

According to an embodiment, the first execution environment and the second execution environment may respectively include a first driver and a second driver that are capable of controlling the state detection circuit. The first state data may be acquired from the state detection circuit through the second driver.

According to an embodiment, the first execution environment may include a rich execution environment (REE). The second execution environment may include a trusted execution environment (TEE).

According to an embodiment, a method performed by an electronic device (e.g., the electronic device 100 of FIG. 1) capable of operating a plurality of execution environments including a first execution environment and a second execution environment, may include acquiring, in the second execution environment, a signature request for a transaction generated through a first application executed in the first execution environment, acquiring first state data through a state detection circuit included in the electronic device in response to the signature request, determining, based on the first state data, whether a signature condition stored in the second execution environment is satisfied, generating, based on the determination result, signature data by executing a digital signature for the transaction with a private key stored in the second execution environment, and transmitting the signature data to the first application.

According to an embodiment, the method may further include displaying, in the first execution environment, a result screen indicating whether the signature condition is satisfied through a display included in the electronic device, based on the determination result.

According to an embodiment, the method may further include acquiring, in the first execution environment, a configuration request for configuring the signature condition and configuration information for the signature condition through the first application, transmitting the configuration request and the configuration information to the second application executed in the second execution environment, configuring, in the second execution environment, the signature condition, based on the configuration request and the configuration information acquired through the second application, and storing the signature condition in the second execution environment.

According to an embodiment, the configuring of the signature condition may include acquiring second state data based on the configuration information from the state detection circuit, and configuring the signature condition, based on the configuration information and the second state data.

According to an embodiment, the setting of the signature condition may include transmitting a confirm request for the signature condition to the first application in the second execution environment, displaying a screen indicating the confirm request through a display included in the electronic device through the first application in the first execution environment, and acquiring a response for the confirm request.

According to an embodiment, the first execution environment and the second execution environment may respectively include a first driver and a second driver that are capable of controlling the state detection circuit. The acquiring of the first state data may be acquiring of the first state data from the state detection circuit through the second driver.

According to an embodiment, the acquiring of the first state data may include deactivating the first driver, and activating the second driver.

As described above, an electronic device (e.g., the electronic device 100 of FIG. 1) may include a display (e.g., the display 120 of FIG. 1), a communication circuit (e.g., the communication circuit 140 of FIG. 1), memory (e.g., the memory 110 of FIG. 1) storing computer-executable instructions including a first application for execution in a first execution environment and a second application for execution in a second execution environment, a state detection circuit (e.g., the state detection circuit 150 of FIG. 1), and at least one processor (e.g., the processor 130 of FIG. 1) communicatively coupled to the state detection circuit, the memory, and the display, and configured to execute at least one of the first application in the first execution environment or the second application in the second execution environment. The computer-executable, when executed by the at least one processor, may cause the electronic device to acquire, in the second execution environment, a signature request for a transaction generated through the first application, acquire first state data through the state detection circuit in response to the signature request, determine, based on the first state data, whether a signature condition stored in the second execution environment is satisfied, transmit the determination result to the first application, and display a result screen indicating the determination result and information on the signature condition in the first execution environment.

According to an embodiment, the result screen may include information on the signature condition not satisfied, in response that the determination result determines that the signature condition is not satisfied.

According to an embodiment, the computer-executable instructions, when executed by the at least one processor, may further cause the electronic device to generate, based on the determination result, signature data by executing a digital signature for the transaction with a private key stored in the second execution environment, and transmit the signature data to the first application.

According to an embodiment, the computer-executable instructions, when executed by the at least one processor, may further cause the electronic device to control the display to display a configuration screen for configuring the signature condition through the first application, acquire a configuration request and configuration information for the signature condition from a user, based on the configuration screen, transmit the configuration request and the configuration information to the second application, set, in the second execution environment, the signature condition, based on the configuration information, according to the acquired configuration request, and store the signature condition in the second execution environment.

According to an embodiment, the computer-executable instructions, when executed by the at least one processor, may further cause the electronic device to transmit, in the second execution environment, a confirm request for the signature condition to the first application, control the display to display, in the first execution environment, a screen indicating the confirm request through the first application, and acquire a response for the confirm request from the user through the first application.

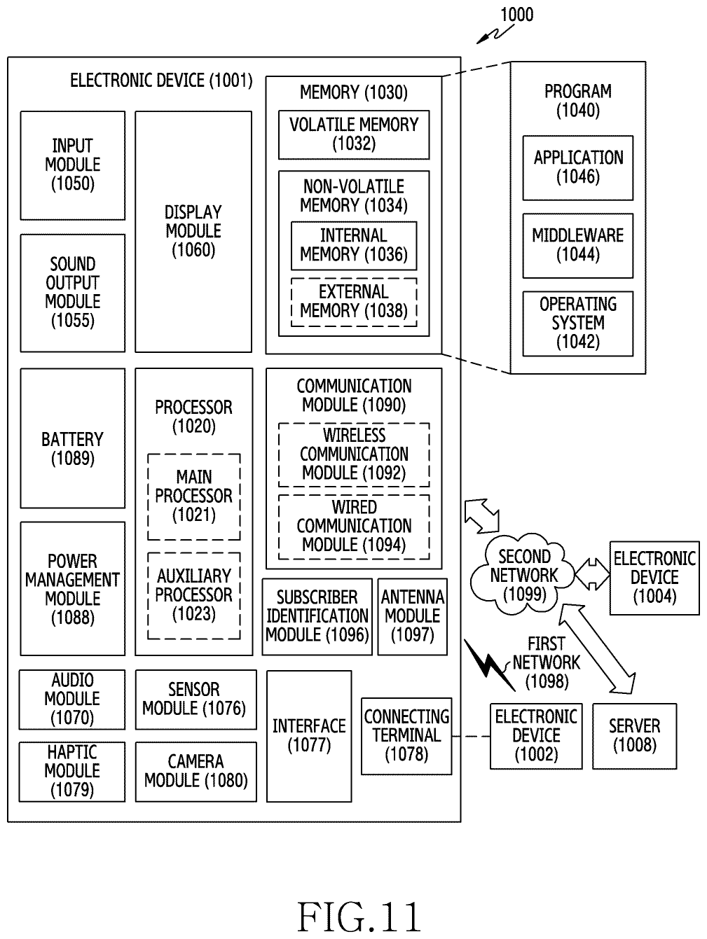

FIG. 11 is a block diagram illustrating an electronic device 1001 in a network environment 1000 according to an embodiment of the disclosure.

Referring to FIG. 11, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5^{th} generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097. According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In an embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a communication circuit;
memory storing computer-executable instructions including a first application for execution in a first execution environment and a second application for execution in a second execution environment;
a state detection circuit; and
at least one processor communicatively coupled to the state detection circuit, the memory, the communication circuit, and the display, and configured to execute at least one of the first application in the first execution environment or the second application in the second execution environment,
wherein the computer-executable instructions, when executed by the at least one processor, cause the electronic device to:
acquire, in the second execution environment, a signature request for a transaction generated through the first application,
acquire first state data through the state detection circuit in response to the signature request,
determine, based on the first state data, whether a signature condition stored in the second execution environment is satisfied,
generate, based on the determination result, signature data by executing a digital signature for the transaction with a private key stored in the second execution environment, and
transmit the signature data to the first application.

2. The electronic device of claim 1, wherein the computer-executable instructions, when executed by the at least one processor, further cause the electronic device to:
display, in the first execution environment, a result screen indicating whether the signature condition is satisfied through the display, based on the determination result.

3. The electronic device of claim 2, wherein the computer-executable instructions, when executed by the at least one processor, further cause the electronic device to:
display, in the first execution environment, a result screen indicating that the signature condition is not satisfied through the display, in response to a determination that the signature condition is not satisfied, and
terminate an operation for the transaction.

4. The electronic device of claim 1, wherein the computer-executable instructions, when executed by the at least one processor, further cause the electronic device to:
acquire, in the first execution environment, a configuration request for configuring the signature condition and configuration information for the signature condition through the first application,
transmit the configuration request and the configuration information to the second application,
configure, in the second execution environment, the signature condition, based on the configuration information, according to the acquired configuration request, and
store the signature condition in the second execution environment.

5. The electronic device of claim 4,
wherein the computer-executable instructions, when executed by the at least one processor, further cause the electronic device to:
acquire, in the second execution environment, second state data based on the configuration information from the state detection circuit, and
wherein the signature condition is configured based on the configuration information and the second state data.

6. The electronic device of claim 4, wherein the computer-executable instructions, when executed by the at least one processor, further cause the electronic device to:
transmit, in the second execution environment, a confirm request for the signature condition to the first application,
display, in the first execution environment, a screen indicating the confirm request through the display by using the first application, and
acquire a response for the confirm request by using the first application.

7. The electronic device of claim 1,
wherein the first execution environment and the second execution environment respectively include a first driver and a second driver that are capable of controlling the state detection circuit, and
wherein the first state data is acquired from the state detection circuit through the second driver.

8. The electronic device of claim 1,
wherein the first execution environment includes a rich execution environment (REE), and
wherein the second execution environment includes a trusted execution environment (TEE).

9. A method performed by an electronic device capable of operating a plurality of execution environments including a first execution environment and a second execution environment, the method comprising:
acquiring, in the second execution environment, a signature request for a transaction generated through a first application executed in the first execution environment;
acquiring first state data through a state detection circuit included in the electronic device in response to the signature request;
determining, based on the first state data, whether a signature condition stored in the second execution environment is satisfied;
generating, based on the determination result, signature data by executing a digital signature for the transaction with a private key stored in the second execution environment; and
transmitting the signature data to the first application.

10. The method of claim 9, further comprising:
displaying, in the first execution environment, a result screen indicating whether the signature condition is satisfied through a display included in the electronic device, based on the determination result.

11. The method of claim 9, further comprising:
acquiring, in the first execution environment, a configuration request for configuring the signature condition and configuration information for the signature condition through the first application;
transmitting the configuration request and the configuration information to a second application executed in the second execution environment;
configuring, in the second execution environment, the signature condition, based on the configuration request and the configuration information acquired through the second application; and
storing the signature condition in the second execution environment.

12. The method of claim 11, wherein the configuring of the signature condition comprises:
acquiring second state data based on the configuration information from the state detection circuit; and
configuring the signature condition, based on the configuration information and the second state data.

13. The method of claim 11, wherein the configuring of the signature condition comprises:
transmitting a confirm request for the signature condition to the first application in the second execution environment;
displaying a screen indicating the confirm request through a display included in the electronic device through the first application in the first execution environment; and
acquiring a response for the confirm request.

14. The method of claim 9,
wherein the first execution environment and the second execution environment respectively include a first driver and a second driver that are capable of controlling the state detection circuit, and
wherein the acquiring of the first state data is acquiring of the first state data from the state detection circuit through the second driver.

15. The method of claim 14, wherein the acquiring of the first state data comprises:
deactivating the first driver; and
activating the second driver.

16. An electronic device comprising:
a display;
a communication circuit;
memory storing computer-executable instructions including a first application for execution in a first execution environment and a second application for execution in a second execution environment;
a state detection circuit; and
at least one processor communicatively coupled to the state detection circuit, the memory, the communication circuit, and the display, and configured to execute at least one of the first application in the first execution environment or the second application in the second execution environment,
wherein computer-executable instructions, when executed by the at least one processor, cause the electronic device to:
acquire, in the second execution environment, a signature request for a transaction generated through the first application,
acquire first state data through the state detection circuit in response to the signature request,
determine, based on the first state data, whether a signature condition stored in the second execution environment is satisfied,
transmit the determination result to the first application, and
display, in the first execution environment, a result screen presenting information for the determination result and the signature condition.

17. The electronic device of claim 16, wherein the computer-executable instructions, when executed by the at least one processor, further cause the electronic device to:
in response to determining that the signature condition is not satisfied as a result of the determination, display the result screen including information for a signature condition that is not satisfied.

18. The electronic device of claim 16, wherein the computer-executable instructions, when executed by the at least one processor, further cause the electronic device to:
generate, based on the determination result, signature data by executing a digital signature for the transaction with a private key stored in the second execution environment, and
transmit the signature data to the first application.

19. The electronic device of claim 16, wherein the computer-executable instructions, when executed by the at least one processor, further cause the electronic device to:
display, in the first execution environment, a configuration screen for configuring the signature condition through the first application,
acquire configuration information for a configuration request and the signature condition by receiving a user input based on the configuration screen,
transmit the configuration request and the configuration information to the second application,
configure, in the second execution environment, in response to the configuration request based on the configuration information, and
store the signature condition in the second execution environment.

20. The electronic device of claim 19, wherein the computer-executable instructions, when executed by the at least one processor, further cause the electronic device to:
transmit a confirm request for the signature condition from the second execution environment to the first application,
control, in the first execution environment, the display to display a screen presenting the confirm request through the first application, and
acquire a user response for the confirm request through the first application.
